(19) United States
(12) Patent Application Publication
(10) Pub. No.: US 2009/0196366 A1
(43) Pub. Date: Aug. 6, 2009

(54) Transmission of Uplink Control Information with Data in Wireless Networks

(76) Inventors: Zukang Shen, Richardson, TX (US); Eko Nugroho Onggosanusi, Allen, TX (US); Tarik Muharemovic, Dallas, TX (US); Runhua Chen, Dallas, TX (US)

Correspondence Address: TEXAS INSTRUMENTS INCORPORATED, P O BOX 655474, M/S 3999, DALLAS, TX, 75265, US

(21) Appl. No.: 12/363,723

(22) Filed: Jan. 31, 2009

Related U.S. Application Data
(60) Provisional application No. 61/026,043, filed on Feb. 4, 2008.
(60) Provisional application No. 61/039,230, filed on Mar. 25, 2008.
(60) Provisional application No. 61/025,956, filed on Feb. 4, 2008.

(51) Int. Cl. H04L 27/28; H04M 1/00

(52) U.S. Cl. 375/260; 455/550.1

(57) ABSTRACT

Within a wireless network, feedback information from one node to another node is necessary to support various functions. The first node receives an allocation of resources for data transmission. The first node generates cyclic redundancy check (CRC) bits for a selected feedback control information type and encodes the selected feedback information and the CRC bits. The encoding of the feedback information and the CRC bits is adaptive based the amount of allocated resources. The encoded feedback information and CRC bits are then transmitted to the other node using a subset of the allocated resources on the physical shared channel that is normally used only for data transmissions.

### CLAIM OF PRIORITY

This application for Patent claims priority to U.S. Provisional Application No. 61/026,043 (Attorney docket TI-65957PS) entitled “Transmission of Rank and CQI in Uplink in the Presence of Data” filed Feb. 4, 2008, which is incorporated by reference herein. This application for Patent also claims priority to U.S. Provisional Application No. 61/039,230 (Attorney docket TI-65957PS1) entitled “Transmission of Rank and CQI in Uplink in the Presence of Data” filed Mar. 25, 2008, which is incorporated by reference herein. This application for Patent also claims priority to U.S. Provisional Application No. 61/025,956 (Attorney docket TI-65956PS) entitled “Transmission of Uplink Control Information in the Presence of Data” filed Feb. 4, 2008, which is incorporated by reference herein.

### FIELD OF THE INVENTION

This invention generally relates to wireless communication, and in particular to providing feedback in orthogonal frequency division multiple access (OFDMA), DFT-spread OFDMA, and single carrier frequency division multiple access (SC-FDMA) systems.

### BACKGROUND OF THE INVENTION

Wireless cellular communication networks incorporate a number of mobile UEs and a number of NodeBs. A NodeB is generally a fixed station, and may also be called a base transceiver system (BTS), an access point (AP), a base station (BS), or some other equivalent terminology. As improvements of networks are made, the NodeB functionality evolves, so a NodeB is sometimes also referred to as an evolved NodeB (eNB). In general, NodeB hardware, when deployed, is fixed and stationary, while the UE hardware is portable.

In contrast to NodeB, the mobile UE can comprise portable hardware. User equipment (UE), also commonly referred to as a terminal or a mobile station, may be fixed or mobile device and may be a wireless device, a cellular phone, a personal digital assistant (PDA), a wireless modem card, and so on. Uplink communication (UL) refers to a communication from the mobile UE to the NodeB, whereas downlink (DL) refers to communication from the NodeB to the mobile UE. Each NodeB contains radio frequency transmitter(s) and the receiver(s) used to communicate directly with the mobiles, which move freely around it. Similarly, each mobile UE contains radio frequency transmitter(s) and the receiver(s) used to communicate directly with the NodeB. In cellular networks, the mobiles cannot communicate directly with each other but have to communicate with the NodeB.

To support dynamic scheduling and multiple-input multiple-output (MIMO) transmission in downlink (DL), several control information feedback bits must be transmitted in uplink. For example, MIMO related feedback information includes: Index of a selected precoding matrix (PMI); transmission rank, which is the number of spatial transmission layers; and supportable modulation and coding schemes (MCS).

Control information feedback bits are transmitted, for example, in the uplink (UL), for several purposes. For instance, Downlink Hybrid Automatic Repeat ReQuest (HARQ) requires at least one bit of ACK/NACK transmitted in the uplink, indicating successful or failed circular redundancy check(s) (CRC). Moreover, a one bit scheduling request indicator (SRI) is transmitted in uplink, when UE has new data arrival for transmission in uplink. Furthermore, an indicator of downlink channel quality (CQI) needs to be transmitted in the uplink to support mobile UE scheduling in the downlink. While CQI may be transmitted based on a periodic or triggered mechanism, the ACK/NACK needs to be transmitted in a timely manner to support the HARQ operation. Note that ACK/NACK is sometimes denoted as ACKNAK or just simply ACK, or any other equivalent term. This uplink control information is typically transmitted using the physical uplink control channel (PUCCH), as defined by the 3GPP working groups (WG), for evolved universal terrestrial radio access (EUTRA). The EUTRA is sometimes also referred to as 3GPP long-term evolution (3GPP LTE). The structure of the PUCCH is designed to provide sufficiently high transmission reliability.

In addition to PUCCH, the EUTRA standard also defines a physical uplink shared channel (PUSCH), intended for transmission of uplink user data. The Physical Uplink Shared Channel (PUSCH) can be dynamically scheduled. This means that time-frequency resources of PUSCH are re-allocated every sub-frame. This (re)allocation is communicated to the mobile UE using the Physical Downlink Control Channel (PDCCH). Alternatively, resources of the PUSCH can be allocated semi-statically, via the mechanism of semi-persistent scheduling. Thus, any given time-frequency PUSCH resource can possibly be used by any mobile UE, depending on the scheduler allocation. Physical Uplink Control Channel (PUCCH) is different than the PUSCH, and the PUCCH is used for transmission of uplink control information (UCI). Frequency resources which are allocated for PUCCH are found at the two extreme edges of the uplink frequency spectrum. In contrast, frequency resources which are used for PUSCH are in between. Since PUSCH is designed for transmission of user data, re-transmissions are possible, and PUSCH is expected to be generally scheduled with less stand-alone sub-frame reliability than PUCCH. The general operations of the physical channels are described in the EUTRA specifications, for example: “3^{rd} Generation Partnership Project; Technical Specification Group Radio Access Network; Evolved Universal Terrestrial Radio Access (E-UTRA); Physical Channels and Modulation (TS36.211, Release 8).”

The uplink control information is transmitted on PUCCH, if there is no concurrent transmission of data in the uplink, as defined by 3GPP E-UTRA. In addition, 3GPP E-UTRA defines that in case both uplink control information and data need to be transmitted in the same uplink subframe, the uplink control information shall be transmitted on the allocated PUSCH resources, together with data. A reference signal (RS) is a pre-defined signal, pre-known to both transmitter and receiver. The RS can generally be thought of as deterministic from the perspective of both transmitter and receiver. The RS is typically transmitted in order for the receiver to estimate the signal propagation medium. This process is also known as “channel estimation.” Thus, an RS can be transmitted to facilitate channel estimation. Upon deriving channel estimates, these estimates are used for demodulation of transmitted information. This type of RS is sometimes referred to as De-Modulation RS or DM RS. Note that RS can also be transmitted for other purposes, such as channel sounding (SRS), synchronization, or any other purpose. Also note that Reference Signal (RS) can be sometimes called the pilot signal, or the training signal, or any other equivalent term.

### BRIEF DESCRIPTION OF THE DRAWINGS

Particular embodiments in accordance with the invention will now be described, by way of example only, and with reference to the accompanying drawings:

FIG. 1 is a pictorial of an illustrative telecommunications network that employs an embodiment of uplink control transmission with data on PUSCH;

FIG. 2 is an example frame structure of FIG. 1;

FIG. 3 is a block diagram illustrating a portion of a transmitter that generates an error protection code that does not include Rank information;

FIG. 4 is a block diagram illustrating a portion of a transmitter that generates an error protection code that includes Rank information;

FIG. 5 is a flow diagram illustrating operation of uplink control transmission with data on PUSCH in the network of FIG. 1;

FIG. 6 is a block diagram of a Node B and a User Equipment for use in the network system of FIG. 1; and

FIG. 7 is a block diagram of a cellular phone for use in the network of FIG. 1.

### DETAILED DESCRIPTION OF EMBODIMENTS OF THE INVENTION

In 3GPP LTE uplink (UL), single carrier OFDMA (SC-OFDMA) is adopted as the transmission scheme. In case UL control information is present with UL data, the coded control and data bits are multiplexed onto different modulation symbols, which are mapped to different resource elements (RE), where an RE is defined as the smallest granularity of a time-frequency resource. A resource block (RB) is defined as the aggregation of several REs.

In this document, a scheme is described in which the number of resource elements or modulation symbols per UL SC-OFDM symbol (i.e. n), as well as the number of UL SC-OFDM symbols (i.e. m), which carry control feedback information, such as coded Rank bits and/or ACKNAK bits, are adapted to the UE channel condition. In essence, n and m can be linked to the MCS and number of resource blocks (RBs) which are scheduled for the UE's UL data transmission. Accordingly, nm is decreased when the channel quality is higher and increased when the channel quality is lower.

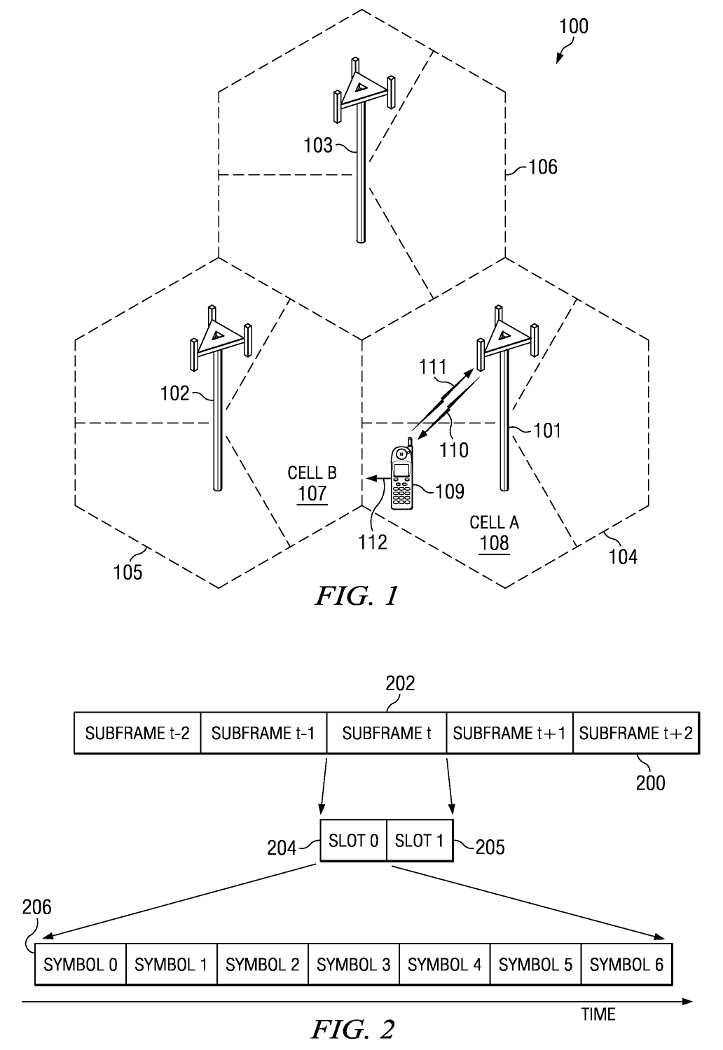

FIG. 1 shows an exemplary wireless telecommunications network 100. The illustrative telecommunications network includes representative base stations 101, 102, and 103; however, a telecommunications network necessarily includes many more base stations. Each of base stations 101, 102, and 103 are operable over corresponding coverage areas 104, 105, and 106. Each base station's coverage area is further divided into cells. In the illustrated network, each base station's coverage area is divided into three cells. Handset or other UE 109 is shown in Cell A 108, which is within coverage area 104 of base station 101. Base station 101 is transmitting to and receiving transmissions from UE 109 via downlink 110 and uplink 111. As UE 109 moves out of Cell A 108, and into Cell B 107, UE 109 may be handed over to base station 102. Because UE 109 is synchronized with base station 101, UE 109 must employ non-synchronized random access to initiate handover to base station 102. A UE in a cell may be stationary such as within a home or office, or may be moving while a user is walking or riding in a vehicle. UE 109 moves within cell 108 with a velocity 112 relative to base station 102. For an uplink subframe, Cell A 108 allocates a set of resource blocks for UE 109 for its PUSCH transmission, either by dynamic scheduling or by semi-persistent scheduling. In case UE 109 needs to feedback uplink control information in the same uplink subframe, UE 109 shall transmit both the uplink control information and data in the allocated PUSCH resource blocks.

Channel quality indicator (CQI) needs to be fed back in uplink (UL) to support dynamic scheduling and multiple-input-multiple-output (MIMO) transmission on downlink (DL). In 3GPP EUTRA, if a UE (user equipment) has no uplink data transmission, its CQI is transmitted on a dedicated UL control channel (i.e. PUCCH). To support dynamic scheduling and multiple-input multiple-output transmission in downlink (DL), several control signaling bits must be fed back in uplink (UL). For example, MIMO related feedback information includes: index of a selected precoding matrix (PMI); transmission rank, which is the number of spatial transmission layers; and supportable modulation and coding schemes (MCS).

In this disclosure, we discuss the transmission schemes for Rank, ACKNAK and CQI in UL, in the presence of UL data. Note that the term CQI may or may not include the precoding matrix indicator (PMI). That is, CQI may comprise of only the recommended spectral efficiency i.e. modulation and coding scheme (MCS), or both MCS and PMI. The rank information has to be received with high reliability, because rank information determines the number of information bits contained in CQI. In other words, CQI is generated using the value of rank information.

Rank and CQI can be jointly coded and transmitted in UL. However, since rank information determines the length of the CQI information bits and consequently the coding scheme, blind decoding is necessary for joint rank and CQI coding, which may not provide satisfactory performance. In this disclosure, separate rank and CQI feedback schemes are described. With separate Rank and CQI transmission, one or more OFDM symbols can be exclusively dedicated for Rank transmission. Furthermore, frequency diversity can be easily achieved by repeating the Rank bits on both slots of a subframe. Furthermore, the encoded Rank bits may be mapped to a certain number of REs or modulation symbols on PUSCH. Although the length of the CQI information bits depends on Rank, the joint Rank and CQI transmission scheme may assume the worst (or longest) CQI length, irrespective of the transmission Rank value. Whenever Rank is decoded erroneously, CQI is incorrectly received. Moreover, for CQI length shorter than the worst case, some coding gains may be lost since the longest CQI length is always assumed.

Note the number of CQI information bits is dependent on Rank. For wideband MIMO related feedback in UL, Table 1 shows exemplary numbers of Rank and CQI bits for joint and separate rank and CQI transmission. For joint transmission, to avoid blind decoding at NodeB, the worst case CQI length needs to be used, irrespective of the Rank value.

TABLE 1
Number of Rank and CQI Bits per Subframe

| | 2-Tx Antennas | | 4-Tx Antennas | |
|---|---|---|---|---|
| | Rank = 1 | Rank = 2 | Rank = 1 | Rank > 1 |
| Separate rank | 1 Rank Bit | 1 Rank Bit | 2 Rank Bits | 2 Rank Bits |
| | 6 CQI Bits | 8 CQI Bits | 8 CQI Bits | 11 CQI Bits |

| | | |
|---|---|---|
| Joint, fixed (no | 9 Bits, Rank + CQI | 13 Bits, Rank + CQI |
| blind decoding) | | |

FIG. 2 is an example frame structure 200 used in FIG. 1. Each frame 200 contains several subframes, as indicated generally at 202. In turn, subframe 202 contains two slots 204, 205. Each slot contains a number of information carrying symbols, generally indicated at 206. A cyclic prefix (CP) field is also appended to each symbol in order to improve reception integrity. In the current E-UTRA standard, each slot contains seven symbols 206 if a normal CP length is used or six symbols 206 if an extended CP length is used. Other embodiments of the invention may provide other frame structures than the exemplary frame structure illustrated in FIG. 2.

As mentioned above, multiple REs or symbols may be used to transmit Rank bits. Denote n as the number of modulation symbols per UL SC-OFDM symbol that are used for the transmission of coded Rank bits. Denote m as the number of UL SC-OFDM symbols, within a subframe, that contain coded Rank modulation symbols. Therefore, there are a total of (nm) modulation symbols for the transmission of coded Rank bits in a subframe. In 3GPP LTE UL, m can be 4 or 8. Without loss of generality, assuming QPSK (quaternary phase shift keying) as the modulation scheme for the transmission of coded Rank bits, the number of coded Rank bits per subframe is 2 nm. Thus, the coding rate (or scheme) for 1 Rank bit is (2 nm, 1) and the coding rate (or scheme) for 2 Rank bits is (2 nm, 2). Since the number of Rank bits is either 1 or 2, a simple repetition coding may be used. Table 2 shows an example of the coding scheme for one Rank bit with n=3 and m=4, while Table 3 shows an example for two Rank bits.

TABLE 2
Coding Scheme for 1 Rank Bit, n = 3, m = 4

| Rank | | | | | | | | | | | | | | | | | | | | | | | | |
|---|---|---|---|---|---|---|---|---|---|---|---|---|---|---|---|---|---|---|---|---|---|---|---|---|
| Bit | Coded Rank bits | | | | | | | | | | | | | | | | | | | | | | | |
| 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 1 | 1 | 1 | 1 | 1 | 1 | 1 | 1 | 1 | 1 | 1 | 1 | 1 | 1 | 1 | 1 | 1 | 1 | 1 | 1 | 1 | 1 | 1 | 1 | 1 |

TABLE 3
Coding Scheme for 2 Rank bits, n = 3, m = 4

| Rank | | | | | | | | | | | | | | | | | | | | | | | | |
|---|---|---|---|---|---|---|---|---|---|---|---|---|---|---|---|---|---|---|---|---|---|---|---|---|
| Bit | Coded Rank bits | | | | | | | | | | | | | | | | | | | | | | | |
| 00 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 01 | 0 | 1 | 0 | 1 | 0 | 1 | 0 | 1 | 0 | 1 | 0 | 1 | 0 | 1 | 0 | 1 | 0 | 1 | 0 | 1 | 0 | 1 | 0 | 1 |
| 10 | 1 | 0 | 1 | 0 | 1 | 0 | 1 | 0 | 1 | 0 | 1 | 0 | 1 | 0 | 1 | 0 | 1 | 0 | 1 | 0 | 1 | 0 | 1 | 0 |
| 11 | 1 | 1 | 1 | 1 | 1 | 1 | 1 | 1 | 1 | 1 | 1 | 1 | 1 | 1 | 1 | 1 | 1 | 1 | 1 | 1 | 1 | 1 | 1 | 1 |

Note the value for n can vary for different UEs. For example, for a UE scheduled with high modulation and coding scheme (MCS) for its UL data transmission, it is presumed that the UE has good channel gain. Thus, it is sufficient for such UE to transmit the coded Rank bits on a small number of REs (or modulation symbols) to achieve the required target performance. On the other hand, for a UE scheduled with low MCS, it is common that this UE does not experience excellent channel condition. Thus, it is crucial for such UE to transmit the coded Rank bits on a larger number of REs (or modulation symbols) to achieve the desired performance. In the current 3GPP compliant embodiment, the candidate values of n can be n=3, 6, 9, or 12. Note the candidate values of m are m=4 or 8. In other embodiments, the range of allowable parameters may be different.

Therefore, in an embodiment of the invention, the number of REs or modulation symbols per UL SC-OFDM symbol (i.e. n), as well as the number of UL SC-OFDM symbols (i.e. m), which carry the coded Rank bits, are adapted to the UE channel condition. In essence, n and m may be linked to the MCS and number of RBs which are scheduled for the UE's UL data transmission.

In another embodiment of the invention, the number of REs or modulation symbols per UL SC-OFDM symbol (i.e. n), as well as the number of UL SC-OFDM symbols (i.e. m), which carry the coded ACKNAK bits, are adapted to the UE channel condition. In essence, n and m may be linked to the MCS and number of RBs which are scheduled for the UE's UL data transmission.

It is not precluded that for simplicity, a fixed value of n and m is adopted to all UEs in the system for the transmission of coded Rank bits. Moreover, it is possible to apply a cell-specific or NodeB specific scrambling code or spreading code to randomize the Rank interference from other cells. The scrambling code or spreading code can be applied to the UL SC-OFDM symbols (possibly including the DM RS SC-OFDM symbol) that contain coded Rank symbols. The spreading codes can be applied on a slot basis or on a subframe basis.

### ACKNAK Transmission

Similarly, ACKNAK may be adaptively transmitted according to channel conditions. Without loss of generality, assuming QPSK as the modulation scheme for the transmission of UL coded ACK/NAK bits, the number of coded UL ACK/NAK bits per subframe is 2 nm. Thus, the coding rate (or scheme) for 1 ACK/NAK bit is (2 nm, 1) and the coding rate (or scheme) for 2 ACK/NAK bits is (2 nm, 2). Since the number of ACK/NAK bits is either 1 or 2, a simple repetition coding scheme may be used. Table 4 shows an example of the ACK/NAK coding scheme for one ACK/NAK bit with n=3 and m=4, while Table 5 shows an example for the ACK/NAK coding scheme for two ACK/NAK bits.

TABLE 4
Coding Scheme for one ACK/NAK Bit, n = 3, m = 4

| A/N | | | | | | | | | | | | | | | | | | | | | | | | |
|---|---|---|---|---|---|---|---|---|---|---|---|---|---|---|---|---|---|---|---|---|---|---|---|---|
| Bit | Coded ACK/NAK bits | | | | | | | | | | | | | | | | | | | | | | | |
| 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 1 | 1 | 1 | 1 | 1 | 1 | 1 | 1 | 1 | 1 | 1 | 1 | 1 | 1 | 1 | 1 | 1 | 1 | 1 | 1 | 1 | 1 | 1 | 1 | 1 |

TABLE 5
Coding Scheme for two ACK/NAK bits, n = 3, m = 4

| A/N | | | | | | | | | | | | | | | | | | | | | | | | |
|---|---|---|---|---|---|---|---|---|---|---|---|---|---|---|---|---|---|---|---|---|---|---|---|---|
| Bit | Coded ACK/NAK bits | | | | | | | | | | | | | | | | | | | | | | | |
| 00 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 01 | 0 | 1 | 0 | 1 | 0 | 1 | 0 | 1 | 0 | 1 | 0 | 1 | 0 | 1 | 0 | 1 | 0 | 1 | 0 | 1 | 0 | 1 | 0 | 1 |
| 10 | 1 | 0 | 1 | 0 | 1 | 0 | 1 | 0 | 1 | 0 | 1 | 0 | 1 | 0 | 1 | 0 | 1 | 0 | 1 | 0 | 1 | 0 | 1 | 0 |
| 11 | 1 | 1 | 1 | 1 | 1 | 1 | 1 | 1 | 1 | 1 | 1 | 1 | 1 | 1 | 1 | 1 | 1 | 1 | 1 | 1 | 1 | 1 | 1 | 1 |

Essentially, assuming QPSK as the modulation scheme for the transmission of coded ACK/NAK bits, for two ACK/NAK bits, a different QPSK symbol conveys different ACK/NAK information bits. The QPSK symbol is repeated nm times. This coding scheme allows effective ACK/NAK DTX detection. The reason is that normal coded data or other control bits (e.g. coded CQI bits) tend to be random QAM (e.g. QPSK or 16 QAM) symbols. Thus, the receiver can coherently add up the supposedly ACK/NAK symbols to perform ACK/NAK DTX detection, by comparing whether the energy of the coherently combined symbol is below or above a certain threshold.

As discussed above, the value for n can vary for different UEs. For example, for a UE scheduled with high modulation and coding scheme (MCS), it is presumed that the UE has good channel gain. Thus, it is sufficient for such UE to transmit the ACK/NAK on a small number of REs (or modulation symbols) to achieve the required target performance. On the other hand, for a UE scheduled with low MCS, it is common that this UE does not experience excellent channel condition. Thus, it is crucial for such UE to transmit the coded ACK/NAK bits on a larger number of REs (or modulation symbols) to achieve the desired performance. The candidate values of n can be n=3, 6, 9, or 12. Note the candidate values of m are m=4 or 8. Therefore, in an embodiment, the number of REs or modulation symbols per UL SC-OFDM symbol (i.e. n), as well as the number of UL SC-OFDM symbols (i.e. m), which carry the coded ACK/NAK bits, are adapted to the UE channel condition. In essence, n and m can be linked to the MCS and number of RBs which are scheduled for the UE's UL data transmission.

It is not precluded that for simplicity, a fixed value of n and m is adopted to all UEs in the system for the transmission of UL (coded) ACK/NAK bits.

Furthermore, it is proposed that ACK/NAK, SRI, and Rank bits are always mapped to different REs (or modulation symbols), such that receiver will not mistake SRI or Rank as ACK/NAK in case of DTX transmission of ACK/NAK.

The REs assigned for ACK/NAK (or SRI, Rank) symbols can be consecutive in one RB, evenly spaced within one RB in each SC-OFDM symbol, or evenly distributed within all scheduled RBs in each SC-OFDM symbol. It is preferable that The REs (or modulation symbols) carrying the coded ACK/NAK bits are assigned in the same RB where the channel condition stays almost constant on all ACK/NAK REs.

If a UE is assigned with multiple RBs, it is not precluded that NodeB informs the UE which RB to use for the transmission of (coded) ACK/NAK bits, such that the ACK/NAK bits are transmitted in the RB which has good channel condition.

Moreover, it is possible to apply a cell-specific or NodeB specific scrambling code or spreading code to randomize the ACK/NAK interference from other cells. The scrambling code or spreading code can be applied to the UL SC-OFDM symbols (possibly including the DM RS SC-OFDM symbol) that contain coded ACK/NAK symbols. The spreading codes can be applied on a slot basis or on a subframe basis.

It is not precluded that different cells can assign different REs for UL ACK/NAK transmission, such that inter-cell ACK/NAK interference is randomized. It is also not precluded that the REs for UL ACK/NAK transmission can hop from subframe to subframe. Alternatively, the scrambling codes or the spreading codes for UL ACK/NAK transmission can hop from subframe to subframe.

### CRC (Cyclic Redundancy Check) Aspects

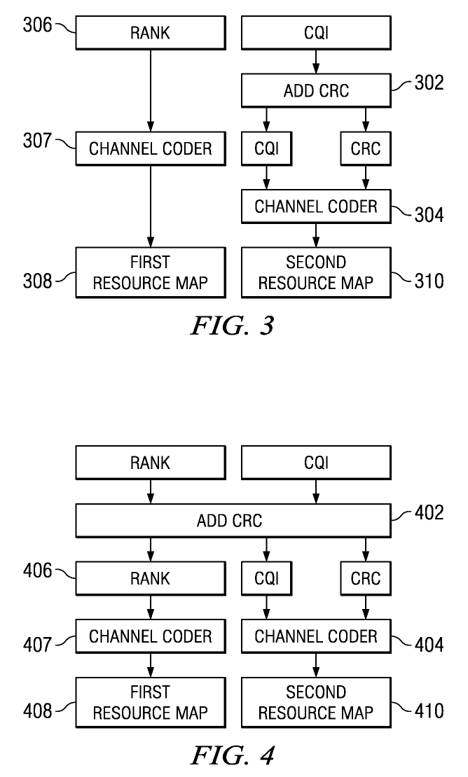

For separate Rank and CQI transmission on PUSCH, it is possible to apply CRC coding for the CQI information bits. FIG. 3 is a block diagram illustrating an embodiment of the disclosure. FIG. 3 shows a portion of a transmitter that generates an error protection code that does not include Rank information. In this embodiment, a CRC (circular redundancy check) operation is applied to CQI information bits by CRC logic 302. In some embodiments, PMI can be treated as a part of CQI information. In other words, CRC can be applied to CQI (not including Rank) information bits. Subsequently, the CQI information bits as well as the corresponding CRC bits are jointly coded using a channel coder 304. The encoded CQI information bits, including the encoded CRC bits, are then mapped to resource elements for transmission using resource map 310 and transmitted on PUSCH. The Rank bits 306 are separately encoded in channel coder 307, mapped into one or more resource elements using resource map 308, and transmitted on different REs on PUSCH than the coded CQI (including CRC) bits. The CRC bits can provide information to the receiver on whether the current CQI bits are correctly received or not. Thus, the receiver can intelligently use the received CQI for scheduling DL transmissions.

It is not precluded that the rank bits can be implicitly transmitted in the CRC. One option is to scramble or mask the CRC bits differently according to different Rank values. Another option is to use different CRC generation polynomials according to the Rank values. An advantage of implicit Rank transmission on CRC is that Rank bits are not explicitly transmitted, which saves overhead. On the other hand, hypothesis testing (or blind decoding) is necessary at the receiver to decode the Rank and CQI bits.

Alternatively, CRC can be applied to the aggregated Rank and CQI information bits. Subsequently, the Rank and CQI information bits, as well as the corresponding CRC bits, are jointly coded and transmitted in PUSCH. In this above approach, the Rank information bits are explicitly transmitted with CQI and CRC. Therefore, one simple (i.e. same to all possible Rank values) CRC is sufficient. However, since the Rank value decides the length of the CQI information bits, hypothesis testing (or blind decoding) is needed at the receiver side.

Note in this disclosure, the REs (or modulation symbols) can refer to the resource (in fine time domain) before the DFT operation in LTE UL, which adopts SC-OFDMA as the transmission scheme.

FIG. 4 is a block diagram illustrating an embodiment of the disclosure. FIG. 4 shows a portion of a transmitter that generates an error protection code that includes Rank information. In this embodiment, a CRC (circular redundancy check) operation is applied to aggregated Rank and CQI information bits by CRC logic 402. In some embodiments, PMI can be treated as a part of CQI information. The “appended” CRC bits are then jointly encoded together with the CQI information bits, using a channel coder 404. The encoded CQI information bits, including the encoded CRC bits, are then mapped to resource elements for transmission using resource map 410. Rank information 406 is separately encoded in channel coder 407, mapped into a resource element using resource map 408, and is transmitted separately, and is not encoded jointly with CQI and CRC bits. In this case, Rank Information (RI) can still be extracted separately by the eNB receiver but is also protected by CRC so that the eNB can do error testing with RI.

In another embodiment, CRC is applied to aggregated ACK/NAK and CQI information bits. The “appended” CRC bits are then jointly encoded together with CQI information bits, using a channel encoder. ACK/NAK information is transmitted separately, and is not encoded jointly with CQI and CRC bits. In some embodiments, PMI can be treated as a part of CQI information. The block diagram of FIG. 4 may be modified to illustrate this embodiment by replacing Rank with ACK/NAK. With such a solution, ACK/NAK can still be extracted separately by the eNB receiver but is also protected by CRC so that the eNB can do error testing. In a typical embodiment, Rank information will be encoded during one symbol time as illustrated in FIG. 4, and ACKNAK information will be similarly encoded during another symbol time.

### Multiplexing Rank and CQI on PUSCH

Once the rank and CQI bits are encoded and modulated, the resulting modulated symbols need to be multiplexed in PUSCH. The following principles may be applied in designing the multiplexing scheme for rank and CQI information. When rank is separately encoded from CQI and hence one modulated control symbol (mapped to one resource element) can contain either CQI or rank, but not both, the rank can be more protected than CQI by placing the rank symbols near the demodulation reference symbols (DMRS). This also ensures that the rank report works well at higher speed. This is necessary since rank adaptation is also supported for higher UE speed. While it is possible to ensure that the CQI symbols are as close as possible to the DMRS, the rank symbols should be prioritized. That is, the rank symbols should be closer to the DMRS compared to the CQI symbols. In addition, whenever possible, some uniform spacing/gap should be introduced between two consecutive REs that are used for rank reporting to ensure maximum diversity gain.

It is also possible to treat CQI the same as regular data on PUSCH. That is, CQI does not have to be positioned as close as possible to the DMRS. This may allow better flexibility for rank multiplexing. When ACK/NAK is also sent via PUSCH, it is preferred to ensure diversity gain of ACK/NAK (which is placed as close as possible to the DMRS) by introducing some uniform spacing/gap between two consecutive REs that are used for ACK/NAK reporting. Hence, the rank symbols can be positioned in alternating RE position with the ACK/NAK symbols. Both ACK/NAK and rank symbols are then positioned as close as possible to the DMRS and in addition attain maximum diversity gain.

Unlike ACK/NAK, the eNodeB anticipates the rank report when periodic reporting is performed (i.e. the eNodeB knows which sub-frames contain the rank report). In this case, there is no need for the rank symbols to puncture the data symbols. That is, a set of dedicated RE locations should be allocated for rank reporting.

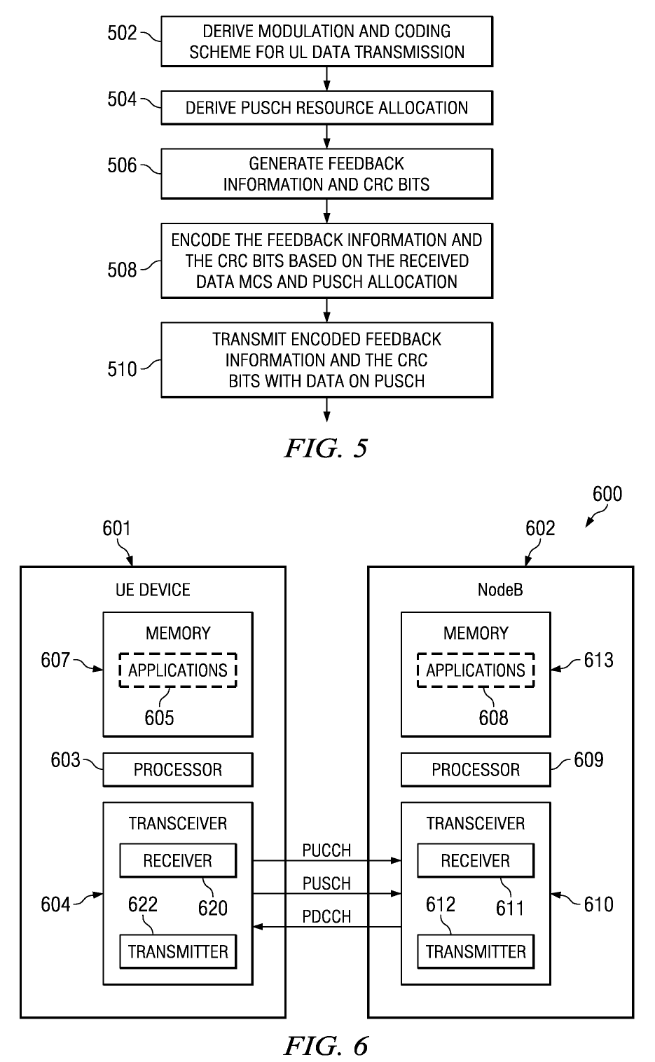

FIG. 5 is a flow diagram illustrating operation uplink control transmission with data on PUSCH in the network of FIG. 1. Based on the estimated uplink channel quality, e.g. by sounding reference signal, the NodeB determines an MCS and an allocation of resource blocks for a UE on PUSCH. The determined MCS and resource allocation are indicated in downlink control channel, either by dynamic scheduling or by semi-persistently scheduling. Upon receiving the control information from eNB, UE derives 502 the modulation and coding scheme (MCS) for uplink data transmission. UE also derives 504 the resources allocation on PUSCH. The resource allocation is also influenced by the amount of uplink data traffic within a cell at any given time.

When the UE is ready to transmit a block of data using the allocated resources, as well as some uplink control information (e.g. Rank, ACK/NAK, or CQI), it determines a coding rate that will be used to transmit each of the uplink control information. In this embodiment, the coding rate is based on the received data MCS and the received PUSCH resource allocation. For each uplink control information, the UE determines the number of modulation symbols n as per UL SC-OFDM symbol that are to be used for the transmission of the uplink control information. It also determines the number of UL SC-OFDM symbols m, within a subframe, that are to be used for the transmission of the uplink control information. Therefore, a total of (nm) modulation symbols (or resource elements) on PUSCH are used for the transmission of each uplink control information in a subframe. Note the values of n and m can be different for different types of uplink control information.

An allocation of resources is received from a NodeB comprising a set of resource elements. The UE generates 506 a first type of control feedback information and generates cyclic redundancy check (CRC) bits for the first type of control feedback information. The UE encodes the first type of control feedback information and the CRC bits and determines a first subset of allocated resource elements, as described in more detail above. The UE then transmits the encoded first type of control feedback information and the CRC bits using the first subset of allocated resource elements. The allocation of resources is for a physical uplink shared channel (PUSCH) used for transmission of data which means the control feedback information that is usually transmitted on the PUCCH will instead be transmitted on the PUSCH.

The UE also generates an amount of data information bits and encodes the data information bits, as described in more detail above. It then determines a second subset of allocated resource elements and transmits the encoded data information bits using the second subset of allocated resource elements on the PUSCH. The first subset of allocated resource elements is determined using the amount of allocated PUSCH resource elements.

The UE then encodes 508 the generated feedback information and the generated CRC bits, based on the received MCS and PUSCH allocation for data. The UE then transmits 510 both the encoded feedback information and data on the allocated PUSCH resource elements using generally known techniques for transmission within the network of FIG. 1.

In case there are multiple control information to be transmitted with data in one uplink subframe, each of the control information can be separately encoded and mapped to different PUSCH resource elements. The coding rate and coding scheme for different types of uplink control information can be different. In addition, CRC bits are generated to a selected set of uplink control information.

### System Examples

FIG. 6 is a block diagram illustrating operation of a NodeB and a mobile UE in the network system of FIG. 1. As shown in FIG. 6, wireless networking system 600 comprises a mobile UE device 601 in communication with NodeB 602. The mobile UE device 601 may represent any of a variety of devices such as a server, a desktop computer, a laptop computer, a cellular phone, a Personal Digital Assistant (PDA), a smart phone or other electronic devices. In some embodiments, the electronic mobile UE device 601 communicates with the NodeB 602 based on a LTE or E-UTRAN protocol. Alternatively, another communication protocol now known or later developed can be used.

As shown, the mobile UE device 601 comprises a processor 603 coupled to a memory 607 and a Transceiver 604. The memory 607 stores (software) applications 605 for execution by the processor 603. The applications 605 could comprise any known or future application useful for individuals or organizations. As an example, such applications 605 could be categorized as operating systems (OS), device drivers, databases, multimedia tools, presentation tools, Internet browsers, e-mailers, Voice-Over-Internet Protocol (VOIP) tools, file browsers, firewalls, instant messaging, finance tools, games, word processors or other categories. Regardless of the exact nature of the applications 605, at least some of the applications 605 may direct the mobile UE device 601 to transmit UL signals to the NodeB (base-station) 602 periodically or continuously via the transceiver 604. In at least some embodiments, the mobile UE device 601 identifies a Quality of Service (QoS) requirement when requesting an uplink resource from the NodeB 602. In some cases, the QoS requirement may be implicitly derived by the NodeB 602 from the type of traffic supported by the mobile UE device 601. As an example, VOIP and gaming applications often involve low-latency uplink (UL) transmissions while High Throughput (HTP)/Hypertext Transmission Protocol (HTTP) traffic can involve high-latency uplink transmissions.

Transceiver 604 includes uplink logic which may be implemented by execution of instructions that control the operation of the transceiver. Some of these instructions may be stored in memory 607 and executed when needed. As would be understood by one of skill in the art, the components of the Uplink Logic may involve the physical (PHY) layer and/or the Media Access Control (MAC) layer of the transceiver 604. Transceiver 604 includes one or more receivers 620 and one or more transmitters 622 for MIMO operation, as described above. The transmitter is configured to provide uplink control information with data on PUSCH to the NodeB as described in more detail above. CQI feedback information with CRC protection is transmitted on the PUSCH with data, as described above.

A pre-defined reference signal is transmitted in the RS symbol. The pre-defined reference signal transmitted in each RS symbol can be the same. Alternatively, the pre-defined reference signals can be different in different RS symbols, provided these pre-defined reference signals are known to both the transmitter and the receiver.

As shown in FIG. 6, the NodeB 602 comprises a Processor 609 coupled to a memory 613 and a transceiver 610. The memory 613 stores applications 608 for execution by the processor 609. The applications 608 could comprise any known or future application useful for managing wireless communications. At least some of the applications 608 may direct the base-station to manage transmissions to or from the user device 601.

Transceiver 610 comprises an uplink Resource Manager, which enables the NodeB 602 to selectively allocate uplink PUSCH resources to the user device 601. As would be understood by one of skill in the art, the components of the uplink resource manager may involve the physical (PHY) layer and/or the Media Access Control (MAC) layer of the transceiver 610. Transceiver 610 includes a Receiver 611 for receiving transmissions from various UE within range of the NodeB and transmitters 612 for transmitting data and control information to the various UE within range of the NodeB.

The uplink resource manager executes instructions that control the operation of transceiver 610. Some of these instructions may be located in memory 613 and executed when needed on processor 609. The resource manager controls the transmission resources allocated to each UE that is being served by NodeB 602 and broadcasts control information via the physical downlink control channel PDCCH. Based on the detected channel conditions and allocated resources for a given transmission session, the NodeB receives control information from the UE that includes CQI, rank information and/or ACKNAK information on the PUSCH according to the channel conditions and allocated resources, as described in more detail above.

The NodeB receives from the a UE an encoded first type of control feedback information using a first subset of the allocated resource elements, wherein the encoded first type of control information comprises a first type of control feedback information and cyclic redundancy check (CRC) bits determined for the first type of control feedback information. It then decodes the first type of control information and the CRC bits from the encoded first type of control feedback information and verifies the first type of control feedback information is correct using the CRC bits.

The NodeB also receives from the UE encoded data information bits using a second subset of the allocated resource elements. It decodes an amount of data information bits from the encoded data information bits, wherein the first subset of allocated resource elements is determined using the amount of allocated resource elements and the amount of data information bits.

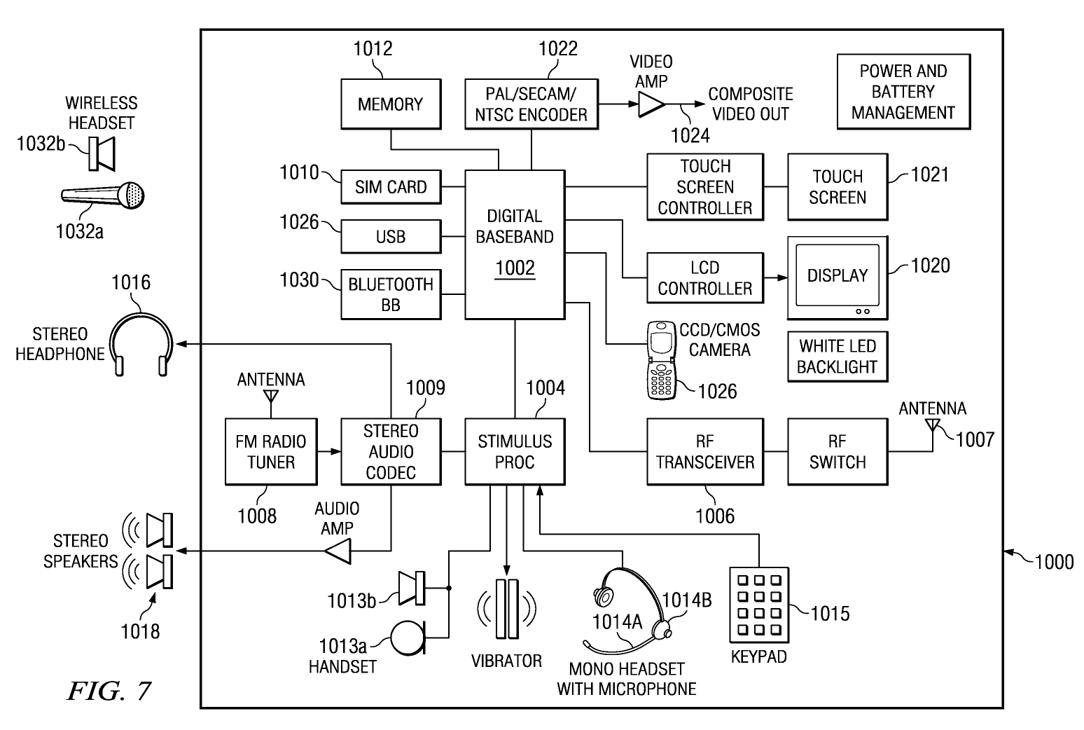

FIG. 7 is a block diagram of mobile cellular phone 1000 for use in the network of FIG. 1. Digital baseband (DBB) unit 1002 can include a digital processing processor system (DSP) that includes embedded memory and security features. Stimulus Processing (SP) unit 1004 receives a voice data stream from handset microphone 1013a and sends a voice data stream to handset mono speaker 1013b. SP unit 1004 also receives a voice data stream from microphone 1014a and sends a voice data stream to mono headset 1014b. Usually, SP and DBB are separate ICs. In most embodiments, SP does not embed a programmable processor core, but performs processing based on configuration of audio paths, filters, gains, etc being setup by software running on the DBB. In an alternate embodiment, SP processing is performed on the same processor that performs DBB processing. In another embodiment, a separate DSP or other type of processor performs SP processing.

RF transceiver 1006 includes a receiver for receiving a stream of coded data frames and commands from a cellular base station via antenna 1007 and a transmitter for transmitting a stream of coded data frames to the cellular base station via multiple antennas 1007 that support MIMO operation. Transmission of the PUSCH data is performed by the transceiver using the PUSCH resources allocated by the serving eNB. In some embodiments, frequency hopping may be implied by using two or more bands as commanded by the serving eNB. In this embodiment, a single transceiver can support multi-standard operation (such as EUTRA and other standards) but other embodiments may use multiple transceivers for different transmission standards. Other embodiments may have transceivers for a later developed transmission standard with appropriate configuration. RF transceiver 1006 is connected to DBB 1002 which provides processing of the frames of encoded data being received and transmitted by the mobile UE unite 1000.

The EUTRA defines SC-FDMA (via DFT-spread OFDMA) as the uplink modulation. The basic SC-FDMA DSP radio can include discrete Fourier transform (DFT), resource (i.e. tone) mapping, and IFFT (fast implementation of IDFT) to form a data stream for transmission. To receive the data stream from the received signal, the SC-FDMA radio can include DFT, resource de-mapping and IFFT. The operations of DFT, IFFT and resource mapping/de-mapping may be performed by instructions stored in memory 1012 and executed by DBB 1002 in response to signals received by transceiver 1006.

For feedback transmission, a transmitter(s) within transceiver 1006 may be configured to provide adaptive feedback with data on PUSCH as described above. Rank indicator and/or ACKNAK and CQI feedback information are transmitted in allocated PUSCH resources, as described above. An allocation of resources is received from a NodeB comprising a set of resource elements. The UE generates a first type of control feedback information and generates cyclic redundancy check (CRC) bits for the first type of control feedback information. The UE encodes the first type of control feedback information and the CRC bits and determines a first subset of allocated resource elements. The UE then transmits the encoded first type of control feedback information and the CRC bits using the first subset of allocated resource elements. The allocation of resources is for a physical uplink shared channel (PUSCH) used for transmission of data which means the control feedback information that is usually transmitted on the PUCCH will instead be transmitted on the PUSCH.

The UE also generates an amount of data information bits and encodes the data information bits. It then determines a second subset of allocated resource elements and transmits the encoded data information bits using the second subset of allocated resource elements on the PUSCH. The first subset of allocated resource elements is determined using the amount of allocated PUSCH resource elements and the amount of data information bits.

A pre-defined reference signal is transmitted in the RS symbol. The pre-defined reference signal transmitted in each RS symbol can be the same. Alternatively, the pre-defined reference signals can be different in different RS symbols, provided these pre-defined reference signals are known to both the transmitter and the receiver.

DBB unit 1002 may send or receive data to various devices connected to universal serial bus (USB) port 1026. DBB 1002 can be connected to subscriber identity module (SIM) card 1010 and stores and retrieves information used for making calls via the cellular system. DBB 1002 can also connected to memory 1012 that augments the onboard memory and is used for various processing needs. DBB 1002 can be connected to Bluetooth baseband unit 1030 for wireless connection to a microphone 1032a and headset 1032b for sending and receiving voice data. DBB 1002 can also be connected to display 1020 and can send information to it for interaction with a user of the mobile UE 1000 during a call process. Display 1020 may also display pictures received from the network, from a local camera 1026, or from other sources such as USB 1026. DBB 1002 may also send a video stream to display 1020 that is received from various sources such as the cellular network via RF transceiver 1006 or camera 1026. DBB 1002 may also send a video stream to an external video display unit via encoder 1022 over composite output terminal 1024. Encoder unit 1022 can provide encoding according to PAL/SECAM/NTSC video standards.

### Other Embodiments

Various other embodiments of the invention will be apparent to persons skilled in the art upon reference to this description. For example, a larger or smaller number of symbols then described herein may be used in a slot. Other types of feedback may be separately embedded and transmitted in configured frames at various times. The term “frame” “subframe” and “slot” are not restricted to the structure of FIG. 2. Other configurations of frames and/or subframes may be embodied. In general, the term “frame” may refer to a set of one or more subframes. A transmission instance likewise refers to a frame, subframe, or other agreed upon quantity of transmission resource in which a feedback indication can be embedded.

While the disclosure has discussed an adaptive scheme for the transmission of feedback information with data on PUSCH that provides error detection capability for the feedback information, other embodiments may use the principles described herein to improve reliability for signaling other types of information that is routinely signaled between nodes in a network that have an aspect of dynamic variability in accuracy based on channel conditions.

As used herein, the terms “applied,” “coupled,” “connected,” and “connection” mean electrically connected, including where additional elements may be in the electrical connection path. “Associated” means a controlling relationship, such as a memory resource that is controlled by an associated port. While the invention has been described with reference to illustrative embodiments, this description is not intended to be construed in a limiting sense.

It is therefore contemplated that the appended claims will cover any such modifications of the embodiments as fall within the true scope and spirit of the invention.

What is claimed is:

1. A method for providing control feedback information in a wireless network, comprising:
receiving an allocation of resources comprising a set of resource elements;
generating a first type of control feedback information;
generating cyclic redundancy check (CRC) bits for the first type of control feedback information;
encoding the first type of control feedback information and the CRC bits;
determining a first subset of allocated resource elements; and
transmitting the encoded first type of control feedback information and the CRC bits using the first subset of allocated resource elements.

2. The method of claim 1, wherein the allocation of resources is for a physical uplink shared channel used for transmission of data.

3. The method of claim 1, further comprising:
generating an amount of data information bits;
encoding the data information bits;
determining a second subset of allocated resource elements; and
transmitting the encoded data information bits using the second subset of allocated resource elements.

4. The method of claim 3, wherein determining the first subset of allocated resource elements further comprises determining the first subset of allocated resource using the amount of allocated resource elements and the amount of data information bits.

5. The method of claim 4, wherein the first type of control feedback information is channel quality indicator (CQI).

6. The method of claim 3, further comprising:
generating a second type of control feedback information bits;
encoding the second type of control feedback information bits;
determining a third subset of allocated resource elements using the amount of allocated resource elements and the amount of data information bits; and
transmitting the encoded second type of control feedback information bits using the third subset of allocated resource elements.

7. The method of claim 6, wherein the second type of control feedback information is selected from a set consisting of rank indictor (RI) and ACK/NAK.

8. The method of claim 6, further comprising:
generating a third type of control feedback information bits;
encoding the third type of control feedback information bits;
determining a fourth subset of allocated resource elements using the amount of allocated resource elements and the amount of data information bits; and
transmitting the encoded third type of control feedback information bits using the fourth subset of allocated resource elements.

9. The method of claim 8, wherein the third type of control feedback information is selected from a set consisting of rank indictor (RI) and ACK/NAK.

10. The method of claim 6, wherein generating the CRC bits uses both the first type of control feedback information and the second type of control feedback information bits; and wherein encoding the second type of control feedback is performed separately from the encoding of the first type of information and the CRC bits.

11. An apparatus for transmitting in a wireless network, comprising:
processing circuitry coupled to a memory, receiving circuitry and transmission circuitry;
the receiving circuitry being operable to receive an allocation of resources for use on an uplink channel;
the processing circuitry being operable to:
generate a first type of control feedback information,
generate cyclic redundancy check (CRC) bits for the first type of control feedback information,
encode the first type of control feedback information and the CRC bits, and
determine a first subset of allocated resource elements; and
the transmitting circuitry being operable to transmit the encoded first type of control feedback information and the CRC bits using the first subset of allocated resource elements.

12. The apparatus of claim 11, wherein the allocation of resources is for a physical uplink shared channel used for transmission of data.

13. The apparatus of claim 11, wherein the processing circuitry is further operable to:
generate an amount of data information bits;
encode the data information bits;
determine a second subset of allocated resource elements; and
the transmitter is operable to transmit the encoded data information bits using the second subset of allocated resource elements.

14. The apparatus of claim 13, wherein determining the first subset of allocated resource elements further comprises determining the first subset of allocated resource using the amount of allocated resource elements and the amount of data information bits.

15. The apparatus of claim 14, wherein the first type of control feedback information is channel quality indicator (CQI).

16. The apparatus of claim 13, wherein the processing circuitry is further operable to:
generate a second type of control feedback information bits;
encode the second type of control feedback information bits;
determine a third subset of allocated resource elements using the amount of allocated resource elements and the amount of data information bits; and
the transmitter is operable to transmit the encoded second type of control feedback information bits using the third subset of allocated resource elements.

17. The apparatus of claim 16, wherein the second type of control feedback information is selected from a set consisting of rank indictor (RI) and ACK/NAK.

18. The apparatus of claim 11 being a cellular telephone.

19. A method for receiving feedback information in a wireless network, comprising:
transmitting an allocation of resources comprising a set of resource elements to another node in the network;
receiving from the other node an encoded first type of control feedback information using a first subset of the allocated resource elements, wherein the encoded first type of control information comprises a first type of control feedback information and cyclic redundancy check (CRC) bits determined for the first type of control feedback information; and
decoding the first type of control information and the CRC bits from the encoded first type of control feedback information.

20. The method of claim 19, wherein the allocation of resources is for a physical uplink shared channel used for transmission of data, and further comprising:
receiving from the other node encoded data information bits using a second subset of the allocated resource elements;
decoding an amount of data information bits from the encoded data information bits, wherein the first subset of allocated resource elements is determined using the amount of allocated resource elements and the amount of data information bits.
